(19) United States
(12) Patent Application Publication
(10) Pub. No.: US 2017/0238569 A1
(43) Pub. Date: Aug. 24, 2017

(54) EDIBLE FOOD PRESERVATIVE

(71) Applicant: EMPIRE TECHNOLOGY DEVELOPMENT LLC, Wilmington, DE (US)

(72) Inventor: Georgius Abidal ADAM, Sydney (AU)

(73) Assignee: EMPIRE TECHNOLOGY DEVELOPMENT LLC, Wilmington, DE (US)

(21) Appl. No.: 15/051,394

(22) Filed: Feb. 23, 2016

(51) Int. Cl. A23B 7/154; B65D 25/14; B65D 81/28; A23B 7/16

(52) U.S. Cl. CPC A23B 7/154; A23B 7/16; B65D 25/14; B65D 81/28; A23V 2002/00

(57) ABSTRACT

An edible preservative may include a polymer carrier and an active agent chemically bonded to the polymer carrier. The active agent may include multiple functional groups, including at least one of, a polyphenolic group, a double bond, a conjugated double bond, or a chelating group.

### BACKGROUND

Many food items are perishable, such as fruits and vegetables. As perishable food is exposed to oxygen and other components in the air, the food decomposes, losing nutritional value, flavor, and visual appeal. One traditional approach to protect perishable food includes coating the food in wax. However, such an approach may be ineffective or may change the flavor or mouth-feel of the food.

Unless otherwise indicated herein, the materials described herein are not prior art to the claims in the present application and are not admitted to be prior art by inclusion in this section.

### SUMMARY

Technologies described herein generally relate to edible food preservatives.

In some examples, the present disclosure may include an edible preservative that has a polymer carrier and an active agent chemically bonded to the polymer carrier. The active agent may include multiple functional groups, including at least one of, a polyphenolic group, a double bond, a conjugated double bond, or a chelating group.

In additional examples, the present disclosure may include a method of preserving food. The method of preserving food may include dissolving a polymer carrier and one or more types of active agents chemically bonded to the polymer carrier in an aqueous solution. As such, each carrier can include the same type of active agent or may have multiple types of active agents. The active agents may include at least one of a phenolic group, an unsaturated active double bond, or a conjugated double bond. The method of preserving food may also include treating a food to be preserved with the aqueous solution, and drying the food to be preserved.

In other examples, the present disclosure may include a storage container. The storage container may include a body to store a perishable food item, and a coating along an inner surface of the body. The coating may include a polymer carrier and one or more active agents chemically bonded to the polymer carrier, where the active agents can be the same or different. The active agents may include a polyphenolic group, and a double bond.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an embodiment of an edible preservative;

FIG. 2 illustrates an embodiment of a storage container including an edible preservative;

FIG. 3 illustrates another embodiment of a storage container including an edible preservative;

FIG. 4 illustrates an additional embodiment of a storage container including an edible preservative;

FIG. 5 illustrates an example of a food with an edible preservative;

FIG. 6 illustrates an example of a structure of an edible preservative; and

FIGS. 7A and 7B illustrate an example of experimental results of food treated with an edible preservative;

arranged in accordance with at least one of the embodiments described herein, and which arrangement may be modified in accordance with the disclosure provided herein by one of ordinary skill in the art.

### DETAILED DESCRIPTION

This disclosure is generally drawn, inter alia, to methods, apparatus, systems, and devices that relate to edible food preservatives. As used herein, the term “food” may include any product for human ingestion (such as fruit, vegetables, meat, etc.) and may also include other perishable products that may not be for human ingestion, such as flowers or greenery. An edible preservative may include a polymer carrier with an active agent covalently bonded to the polymer carrier. In some embodiments, the active agent may be associated with the polymer carrier by being contained in or on the polymer carrier. In one example, the active agent associated with the carrier without being chemically bonded thereto, such as by being distributed in or encapsulated in the carrier or otherwise immobilized on the surface. The active agent may provide preserving properties to the edible preservative. For example, the active agent may provide antioxidant properties, oxygen absorbing properties, free radical scavenging properties, or chelating properties. The edible preservative may then be applied to or disposed proximate to perishable food in order to extend the stability of food. For example, the edible preservative may increase the length of time in which the food may maintain look, feel, or nutritional value.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

In some embodiments, an edible preservative in accordance with the present disclosure may function to regulate or modify the atmosphere around the food. For example, the edible preservative may function to reduce respiration of the food if the food is a fruit or vegetable by creating a barrier to certain gases. As another example, the edible preservative may change the concentration of certain gases around the food. In some embodiments, modification in the atmosphere by the edible preservative may decrease oxygen levels or increase carbon dioxide levels in the atmosphere around the food. For example, some food such as fruits, vegetables, flowers, or greenery may experience breakdown of photosynthates after being harvested. Such breakdown may utilize or be accelerated by oxygen, and by decreasing oxygen levels around the food, the rate of respiration may be decreased. The rate of respiration may be proportional to the rate of deterioration of such a food product, and thereby decreasing respiration can decrease deterioration of the food product.

The systems and methods described herein can be beneficially used for preservation of post-harvest cultivated food in order to increase shelf life and allow for consumption of cultivated food long after harvesting. However, the systems and methods may also be used for processed foods to enhance preservation thereof. The systems and methods may be employed in any geographic area, and may be applied at any time after cultivation or production of the food. However, it may be beneficial to implement the systems and methods soon after harvesting or production, which may include such systems being utilized in agricultural areas, such as farms, or in general food processing, preparation or cooking plants or operations. The systems and methods may be beneficial in areas that lack standard industrialization and processing of foods, such as in developing countries, and may also be utilized in industrialized regions and implemented in the processing of foods on large scales.

The systems and methods may also be utilized in stores to preserve the foods, and may be included in packaging having the foods. As such, the packaging that utilizes the systems and methods may retain the food to have good quality after purchase and prior to consumption, and during any transportation or storage of the food. The systems and methods may also be used in homes for increased food preservation and shelf life. The system and methods may also be used for increasing food preservation in food supplies or food storage systems, such as emergency food storage (e.g., grain, seeds, preserved species, etc.) that is intended to have very long shelf lives (e.g., 5 years, 10 years, 30 years, etc.). The systems and methods may also be adapted to be used for food transportation in instances without traditional refrigeration. An example of a use can include hiking or backpacking, where the systems and methods can preserve the food during such activities for longer preservation without refrigeration. On the other hand, the systems and methods may be practiced in food packaging in refrigerators or freezers. The food packaging utilizing the systems and methods may be pressurized or at normal (e.g., ambient) pressures or in a vacuum. Accordingly, the systems and methods may be practiced at a range of temperatures and pressures. Thus, the systems and methods can be utilized anywhere for enhanced preservation and shelf life extension of foods.

The systems and methods can be utilized for increasing preservation and shelf life of cultivated food (e.g., food grown and cultivated from the earth that is harvested) or prepared food (e.g., food that is prepared in some matter, such as cutting, slicing or dicing with or without cooking) or cooked food (e.g., food that is cooked). The food may be plant-based or animal-based or combination thereof.

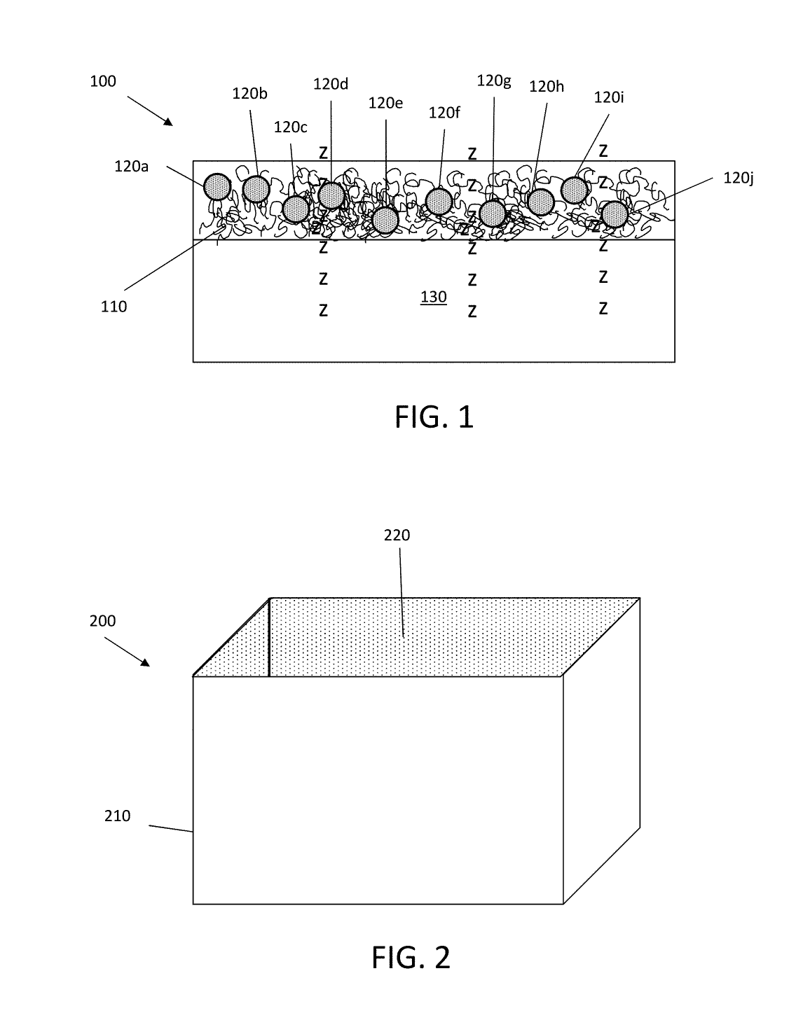

FIG. 1 illustrates an embodiment of an edible preservative 100. The edible preservative 100 may include a polymer carrier 110 and one or more active agents 120 (e.g., the active agents 120a-120j) coupled to the polymer carrier 110. For example, the active agents 120 may be covalently bonded to the polymer carrier. The edible preservative may be used to treat a surface 130. For example, the surface may be a food that is treated with the edible preservative, or may include a storage container treated with the edible preservative. The polymer carrier 110 and the active agents 120 are not illustrated to scale, and are used for illustrative purposes only.

The polymer carrier 110, in some embodiments, may include a polymer that is edible or has otherwise been identified as safe for human consumption. Examples of such polymers may include natural polymers, modified natural polymers, or synthetic polymers. Examples of natural polymers that may be used in an edible food preservative in accordance with the present disclosure may include a starch, a cellulose derivative, a chitosan, a gellan, an algenate, a pectin, a whey, or combinations thereof. Examples of modified natural polymers that may be used in an edible food preservative in accordance with the present disclosure may include a cellulose ester, hydroxyl methyl cellulose, carboxymethyl cellulose, a starch ester, starch carboxylic acid adducts, esterified pectin, or combinations thereof. An adduct may include a combination of two molecules in which the product retains all of the components of the two materials (e.g., a carboxylic acid and an amine may form an adduct). Examples of synthetic polymers that may be used in an edible food preservative may include a polyvinyl alcohol (PVA), a polyethylene glycol (PEG), a polylactone, or combinations thereof. In these and other embodiments, the polymer carrier may include more than one base polymer, for example, a combination of natural, modified natural, and synthetic polymers may be included in a single edible preservative. In some embodiments, the polymer used as the polymer carrier may be selected to effectively chemically bond with a desired active agent. For example, a starch may be selected to form a chemical bond with gallic acid if gallic acid is the active agent 120.

In some embodiments the active agent 120 may include a molecule that includes a functional group that provides a target property to the edible preservative 100, such as an antioxidant property. In these and other embodiments, the active agent 120 may include multiple functional groups such that the active agent 120 may form a chemical bond with the polymer carrier 110 with a first functional group and may retain a second, unreacted functional group that may provide the target property. For example, an active agent 120 may include two or more polyphenolic groups, double bonds (such as active double bonds, or in other words, a double bond with a functional group adjacent to the double bond to make the double bond more reactive, such as a double bond adjacent to a carboxylic acid, etc.), conjugated double bonds, chelating groups, or combinations thereof. A conjugated double bond may include one of a group of two or more double bonds with single bonds alternating between the double bonds (e.g., a first double bond, a first single bond, a second double bond, and a second single bond in series). In such a conjugated double bond, the conjugated double bond may react and shift the electrons from the double bond to the single bond to form a double bond, which may displace the next double bond to the next single bond, etc. Examples of active agents 120 in an edible preservative in accordance with the present disclosure may include α-carotene, β-carotene, oxalic acid, leucic acid, ascorbic acid, gallic acid, ellagic acid, glutathione, α-tocopherol, α-tocopherol, rosmarinic acid, daidzein, catechins, tocotrienol, p-coumaric acid, vanillic acid, syringic acid, caffeic acid, ferulic acid, cinnamic acid, oleuropein, luteolin, quercetin, myricetin, flavonoids, and combinations thereof.

In some embodiments, the active agent 120 may be selected based on a target property of the active agent 120. For example, an active agent 120 with a polyphenolic group may be selected such that the edible preservative 100 may be an antioxidant and/or a free radical scavenger. For example, a polyphenolic group (e.g., a group with more than one carbon ring with conjugated double bonds and an alcohol attached to the ring) may react with a free radical to stabilize the free radical by providing an electron because of the stability of the ring system. As another example, an active agent 120 with a double bond may be selected such that the edible preservative 100 may be an oxygen absorber. For example, the double bond may react with electrons from oxygen to form an alcohol or a carboxylic acid. As an additional example, an active agent 120 with a chelating group may be selected such that the edible preservative 100 may be a transition metal deactivator. For example, two ligands of a chelating group (e.g., a functional group able to form two or more bonds between ligands of the functional group and a central atom) may both bond to a transition metal to stabilize or deactivate the transition metal when bonded to the chelating group.

In some embodiments, the edible preservative 100 in accordance with the present disclosure may provide additional nutritional benefit to a human that ingests the edible preservative. For example, the active agent 120 may include a vitamin, provitamin, or other agent that may provide a nutritional benefit to the consumer.

In some embodiments, the polymer carrier 110 may include one or more sites to form hydrogen bonds and/or ionic bonds. For example, the polymer carrier 110 may form such bonds between polymer molecules. Such bonding may provide the edible preservative 100 with an oxygen barrier and/or a moisture barrier. Additionally or alternatively, the active agent 120 may include one or more sites to form hydrogen bonds and/or ionic bonds. For example, the edible preservative 100 may include hydrogen bonding between and among the polymer carrier 110 (both intermolecular and intramolecular) and between the polymer carrier 110 and the active agent 120. In these and other embodiments, such hydrogen and/or ionic bonding may occur at one of the functional groups of the active agent 120 while leaving another of the functional groups available to provide the target functionality (e.g., antioxidant properties, chelating agent, transition metal stabilizer, etc.). Additionally or alternatively, the hydrogen bonding and/or ionic bonding may be broken or displaced during utilization of the target functionality.

In some embodiments, associating an active agent 120 with a polymer carrier 110 may include chemically bonding the active agent 120 to the polymer carrier 110. For example, a condensation reaction may be utilized to form an ester, an amide, or an anhydride between the polymer carrier 110 and the active agent 120. As another example, the polymer carrier 110 and the active agent 120 may form an adduct. In some embodiments, the active agent 120 may include multiple active agents 120 coupled together with the polymer carrier 110. For example, a first active agent (e.g. ascorbic acid) may be reacted with a second active agent (e.g., gallic acid) and the combined active agent may be coupled to the polymer carrier 110. Additionally or alternatively, in some embodiments, an active agent 120 may function as the polymer carrier 110. For example, ellagic acid as the active agent 120 may be polymerized through a condensation reaction to form poly-ellegate ester (illustrated below and where n is an integer).

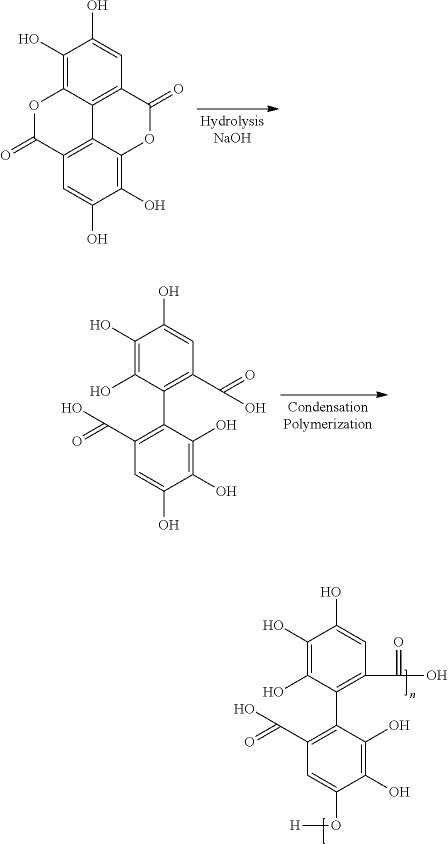

Additionally or alternatively, a first active agent 120 may serve as the polymer carrier 110 and a second active agent 120 may serve as an additional active agent. For example, ellagic acid may be polymerized to serve as the polymer carrier 110 and gallic acid may serve as the active agent 120, forming poly ellagate ester with gallate active groups.

In some embodiments, associating the active agent 120 with the polymer carrier 110 may include disposing the active agent 120 within a nanostructure of the polymer carrier 110. For example, an edible polymer such as cyclodextrin may create a nanotubular structure within which the active agent 120 or associated salts or esters may be disposed. Additionally or alternatively, the active agent 120 may function as a poly-salt or ester of the active agent 120. For example poly-salts of ascorbic acid such as combination of calcium ascorbate, magnesium ascorbate, and/or zinc ascorbate may be disposed within the matrix of the polymer carrier 110.

In some embodiments, composition of a preservative may include between approximately 1% and 15% percent, or between 2% and 10%, or between 3% and 8% by weight of an active agent. Additionally or alternatively, composition of the preservative may include between approximately 85% and 99%, or between 87% and 95%, or between 89% and 93% by weight of a polymer carrier.

By way of specific examples of some embodiments: if the polymer carrier is starch and the active agent is oxalic acid (starch oxallate), the oxalic acid may comprise approximately between 3% and 12%, or between 4% and 10% or between 5% and 8% by weight of the preservative; if the polymer carrier is starch and the active agent is gallic acid (starch gallate), the gallic acid may comprise approximately between 2% and 9%, or between 3% and 8% or between 4% and 7% by weight of the preservative; if the polymer carrier is starch and the active agent is leucic acid (starch leucine), the leucic acid may comprise approximately between 2% and 5%, or between 2.3% and 4.5%, or between 3% and 4% by weight of the preservative; if the polymer carrier is starch and the active agent is ascorbic acid (starch ascorbate), the ascorbic acid may comprise approximately between 4% and 14%, or between 4.5% and 13.6%, or between 5% and 12%, or between 6% and 10% by weight of the preservative; if the polymer carrier is PVA and the active agent is gallic acid (PVA gallate), the gallic acid may comprise approximately between 2% and 11%, or between 2% and 10.5%, or between 3% and 9%, or between 4% and 8%; if the polymer carrier is PVA and the active agent is oxalic acid (PVA oxallate), the oxalic acid may comprise approximately between 2% and 13%, or between 2.5% and 12.2%, or between 4% and 10%, or between 5% and 8% by weight of the preservative; if the polymer carrier is PVA and the active agent is leucic acid (PVA leucine), the leucic acid may comprise approximately between 1% and 3%, or between 1% and 2%, or between 2% and 3% by weight of the preservative; and if the polymer carrier is PVA and the active agent is ascorbic acid (PVA ascorbate), the ascorbic acid may comprise approximately between 3% and 14%, or between 3.3% and 13.5%, or between 5% and 11%, or between 6% and 9% by weight of the preservative.

Modifications, additions, or omissions may be made to FIG. 1 without departing from the scope of the present disclosure. For example, more or fewer components than those illustrated in FIG. 1 may be included in the edible preservative 100. For example, the edible preservative 100 may include multiple different types of active agents, or one active agent may function as the polymer carrier.

FIG. 2 illustrates an embodiment of a storage container 200 including an edible preservative. The storage container 200 may include a body 210 within which food may be stored, and a coating along an inner surface 220 of the body. Any storage container used to store, ship, transport, or serve food may be treated with a preservative in accordance with the present disclosure. For example, the storage container 200 may include a cardboard box, a shipping crate, a polymer foam (e.g. STYROFOAM®) crate, a plastic shell (e.g., a plastic “clamshell” container), a stretchable plastic film, a polymer foam slab, a jar, a bag, or any combinations thereof.

In some embodiments, the storage container 200 may prevent all or a substantial portion of ambient air from entering the body 210 of the storage container 200. Additionally or alternatively, the storage container 200 may be open such that ambient air may circulate within the body 210 of the storage container 200.

In some embodiments, the inner surface 220 of the body 210 of the storage container may be treated with an edible preservative. For example, the edible preservative may be sprayed on the inner surface 220 of the storage container 200, or the entire storage container. As another example, the storage container 200 may be dipped in a solution including the preservative. Such treatment may be part of a manufacturing process of the storage container 200, or may be a separate treatment process of the storage container 200.

Modifications, additions, or omissions may be made to FIG. 2 without departing from the scope of the present disclosure. For example, more or fewer components than those illustrated in FIG. 2 may be included in the storage container 200.

As another example, the storage container 200 may take any shape or form.

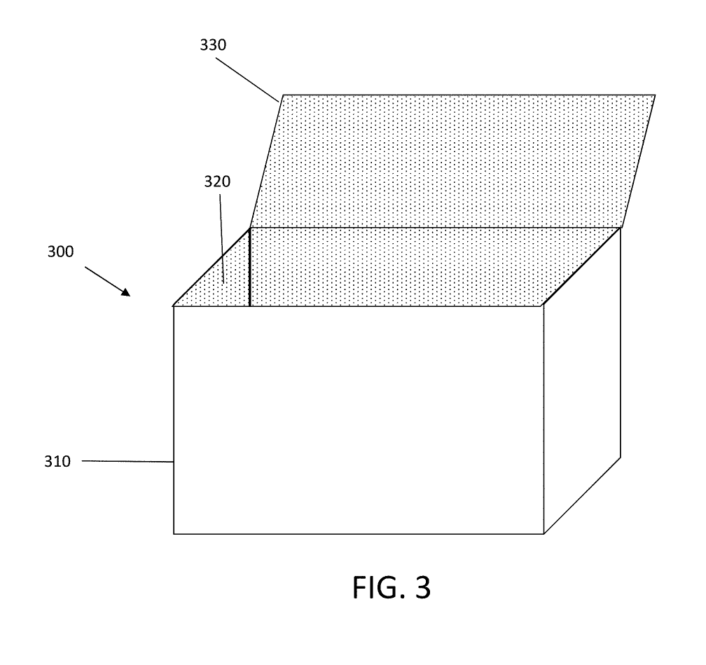

FIG. 3 illustrates another embodiment of a storage container 300 including an edible preservative. The storage container 300 may include a body 310 and an edible preservative on at least an inner surface 320 of the body 310. The storage container 300 may additionally include a lid 330 to enclose the body 320 of the storage container 300. In some embodiments, the lid 330 may include a hinged lid. For example, a plastic “clamshell” storage container may include a hinged lid, or a cardboard box may include multiple hinged portions of the lid.

Modifications, additions, or omissions may be made to FIG. 3 without departing from the scope of the present disclosure. For example, more or fewer components than those illustrated in FIG. 3 may be included in the storage container 300. As another example, the storage container 300 may take any shape or form.

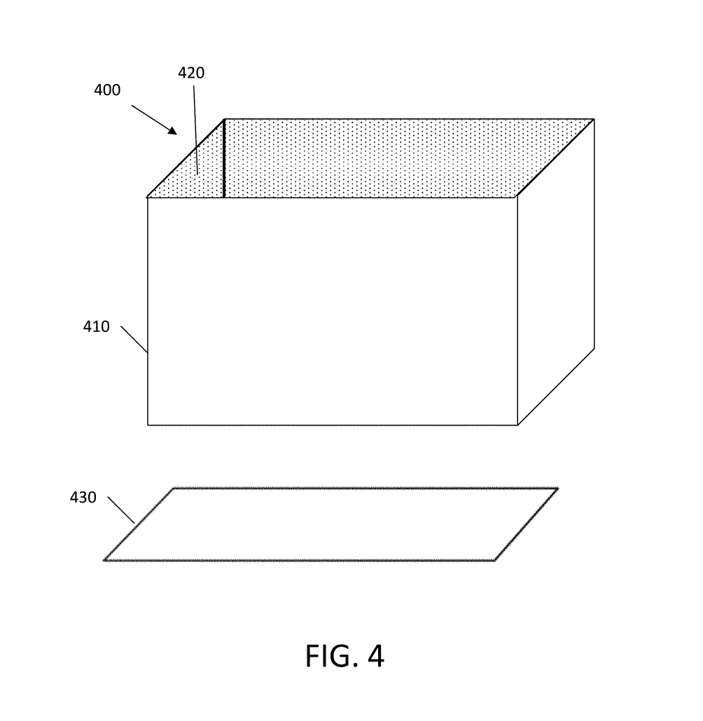

FIG. 4 illustrates an additional embodiment of a storage container 400 including an edible preservative. The storage container 400 may include a body 410 and an edible preservative on at least an inner surface 420 of the body 410. The storage container 400 may additionally include a lid 430 to enclose the body 420 of the storage container 400. The lid 430 may be completely removable from the rest of the storage container 400. For example, a polymer foam crate may include a lid that is removable and/or engages with the storage container via a friction fit to close the body of the storage container.

Modifications, additions, or omissions may be made to FIG. 4 without departing from the scope of the present disclosure. For example, more or fewer components than those illustrated in FIG. 4 may be included in the storage container 400. As another example, the storage container 400 may take any shape or form.

Food may be stored, shipped, or served in a storage container in accordance with the present disclosure. For example, a first storage container treated with an edible preservative (e.g., an open polymer foam crate) may be used to store harvested apples in a farmer's barn. The apples may be packaged in a second storage container treated with an edible preservative (e.g. a cardboard box) and may be used to ship the apples to a grocery store distribution location. The grocery store distribution location may package the apples in a third storage container treated with an edible preservative (e.g. a plastic clamshell) for distribution to a grocery store and for sale to consumers of the apples. A consumer of the apples may have a fourth storage container treated with an edible preservative (e.g. a plastic bag) at the home of the consumer that the apples are placed in until they are eaten.

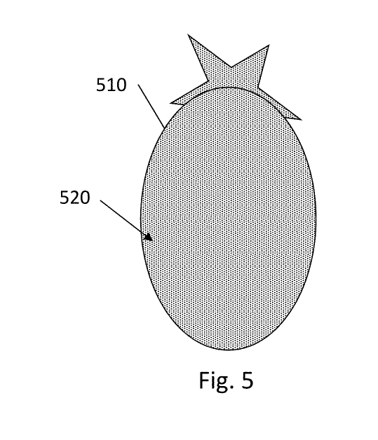

FIG. 5 illustrates an example of food 510 with an edible preservative 520 (illustrated by the hash marks on the fruit 510). In some embodiments, the edible preservative 520 and/or the polymer carrier of the edible preservative may be dissolved in a solution, such as an aqueous solution. In these and other embodiments, the food 510 may be treated with the solution containing the edible preservative 520 to apply the edible preservative 520 to the food. For example, the food 510 may be dipped in the solution, or the solution may be sprayed on the food 510. In some embodiments, after being treated with the solution, the food 510 may be dried to remove the solution and leave the edible preservative 520 on the food. For example, the food 510 may be air dried, placed under a blower, placed under negative pressure, or any other drying technique. In some embodiments where the food 510 may be for human ingestion, the solution may be selected to be edible such that any unevaporated solution may be innocuous to consumers of the food 510. In some embodiments, the solution may be slightly acidic or slightly basic, for example, an aqueous solution with ascorbic acid.

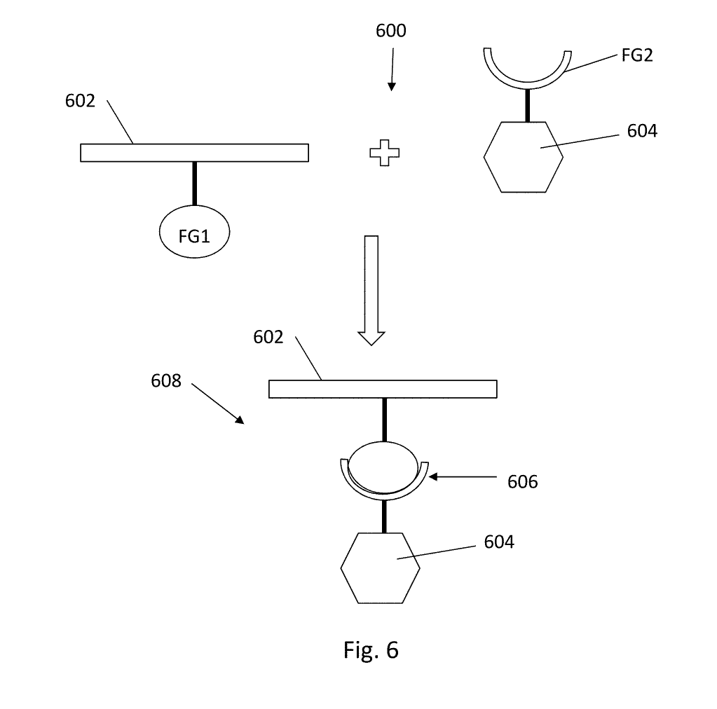

In one embodiment, the preservative composition can include the active agent conjugated to the carrier. The carrier can be a polymer or another active agent. As such, the preservative can include a structure prepared by a process 600 as shown in FIG. 6. As shown, a carrier 602 with a first functional group FG1 is reacted with an active agent 604 with a second functional group FG2 to form the preservative 608 that includes the carrier 602 linked through a linker 606 to the active agent 604. Here, the carrier 602 can be any of the carriers described herein or generally known in the art, whether polymer or other carrier, and the active agent 604 can be any of the active agents that can perform the functions described herein. The first functional group FG1 can be any functional group that can be chemically reacted with the second functional group FG2 so as to form the linker 606, where the linker 606 is a reaction product of the first functional group FG1 and the second functional group FG2. Examples of first functional group FG1 and/or second functional group FG2 can be carboxylic acids, hydroxyls, thiols, amines, alkenes, alkynes, halides, ethers, sulfides, phenyls, phosphines, aldehydes, ketones, carboxylic derivatives, or others. The linker 605 can be the reaction product of such first functional groups and second functional groups, and may include amides, esters, imides, carboxyls, ethers, thioamides, ureas, thioureas, or others. The reactions can be tailored depending on the type of the first functional group FG1 on the carrier 602 and second functional group FG2 on the active agent 604 in order to generate the linker 605. The linker is often covalent; however, in some instances the linker may be ionic. One skilled in the art can determine the first functional group FG1 of the carriers 602 described herein and the second functional group FG2 of the active agents 604 described herein, and thereby determine the resulting linker 605 that forms therefrom.

In one example, starch gallate can be prepared by reacting an a hydroxy of the starch carrier with a carboxylic acid of gallic acid active agent to form an ester linker. In another example, a hydroxyl of a carrier can be reacted with a carboxylic acid of active agent to form an ester linker. Other reactions and reaction products are well within the skill of one of ordinary skill in the art based on the disclosure provided herein so as to form the preservative that includes a carrier covalently linked through a linker to an active agent.

In one embodiment, a multifunctional active agent can be reacted to form a polymer having multiple units of the active agent. Often, the active agent is bifunctional so that the two functional groups react with each other to form the polymer having the active agent units. Also, two or more different multifunctional active agents (e.g., bifunctional) can be reacted to form co-polymers having the different active agent units. In one example, ellagic acid is hydrolyzed to result in a bifunctional active agent that can be condensed into a poly(ellagate ester) as shown in Scheme 1.

Any of a variety of synthesis methods may be utilized in forming edible preservatives in accordance with the present disclosure. Examples of some synthesis methods may be described in Examples 1-7.

### Example 1

One or more embodiments of the present disclosure may include a PVA polymer and ascorbic acid active agent forming a PVA ascorbate ester. In these and other embodiments, synthesis of the PVA ascorbate ester may include fitting a reaction vessel with magnetic stirrer and charged with 100 milliliters (ml) concentrated sulphuric acid. 5 grams (g) of ascorbic acid may was added and dissolved. The acid mixture was cooled to 5-10 C.° to prevent PVA slumps formation followed by addition of 5 g of polyvinyl alcohol powder portion-wise with efficient mixing until a homogenous solution was obtained. The reaction was continued at room temperature for two hours. Samples were taken each 15 minutes for analyses. At the end of the reaction time, the reaction mixture was cooled in an ice bath and then neutralized with 20% sodium hydroxide solution. The first three fractions were water soluble and precipitated by addition of ethanol. A purple color water soluble product was obtained, washed with ethanol, and dried. Additionally, the two hour sample was insoluble in water, ethanol, acetone, and/or CHCl₃. In some embodiments, synthesis products were analyzed by infrared spectroscopy, thermogravimetric analysis, and/or nuclear magnetic resonance spectroscopy.

### Example 2

One or more embodiments of the present disclosure may include a PVA polymer and gallic acid active agent forming a PVA gallate ester. In these and other embodiments, synthesis of the PVA gallate ester may include a similar procedure used in Example 1. For example, fractions were taken each 15 min., cooled in ice bath, and neutralized with 20% sodium hydroxide solution. At the end of the reaction time (e.g., two hours), a dark brown homogenous viscous solution was obtained. The precipitate was filtered, washed with ethanol, and dried. Additionally or alternatively, such a sample was analyzed by infrared spectroscopy, thermogravimetric analysis, and/or nuclear magnetic resonance spectroscopy.

### Example 3

One or more embodiments of the present disclosure may include a PVA polymer and gallic acid active agent forming a PVA gallate ester. In some embodiments, the PVA gallate ester may be synthesized using a microwave. In these and other embodiments, a sample tube was charged with 2 g of PVA powder, and 0.25 g of gallic acid. The mixture was mixed well and put in a microwave for 3 minutes, and any product extracted with methanol. Product PVA gallate is soluble in hot methanol, while unreacted PVA is insoluble in methanol. Product samples were analyzed by infrared spectroscopy, thermogravimetric analysis, and/or nuclear magnetic resonance spectroscopy.

### Example 4

One or more embodiments of the present disclosure may include a starch polymer and gallic acid active agent forming a starch gallate ester. In these and other embodiments, a round bottom reaction flask was charged with 50 ml dimethyl sulfoxide (DMSO), 5 g starch, 5 g gallic acid, and 3 ml concentrated HCl. The round bottom reaction flask was mixed with a magnetic stirrer immersed in an oil bath and heated to 100 C.° for approximately 3 hours. At the end of reaction time, the mixture was cooled in ice bath, neutralized with sodium bicarbonate powder, and precipitated with absolute ethanol. The solid product was highly hygroscopic. The solid product was dried under vacuum. Additionally or alternatively, the product was analyzed by infrared spectroscopy, thermogravimetric analysis, and/or nuclear magnetic resonance spectroscopy.

### Example 5

One or more embodiments of the present disclosure may include a starch polymer and gallic acid active agent forming a starch gallate ester. In some embodiments, starch gallate ester may be synthesized using a microwave. In these and other embodiments, a sample tube was charged with 2 g of starch powder and 0.25 g of gallic acid. The mixture was mixed well and put in a microwave for 3 minutes. The product was extracted with methanol. The starch gallate ester was soluble in hot methanol, while unreacted starch is insoluble in methanol. In these and other embodiments, the product was analyzed by infrared spectroscopy, thermogravimetric analysis, and/or nuclear magnetic resonance spectroscopy.

### Example 6

One or more embodiments of the present disclosure may include a starch polymer and gallic acid active agent forming a starch gallate ester. In some embodiments, the starch gallate ester may be synthesized using a microwave and a catalyst. In these and other embodiments, a sample tube was charged with 2 g of starch powder, 0.25 g of gallic acid, and 0.025 g of iodine as a catalyst. The sample tube was mixed well and left at room temperature for 3 hours to allow 12 to form a reactive complex with the starch. The sample tube was be placed in a microwave for 3 minutes. A brown colored product was formed and extracted with methanol. The starch gallate ester was soluble in hot methanol, while unreacted starch was insoluble in methanol. In these and other embodiments, the product was analyzed by infrared spectroscopy, thermogravimetric analysis, and/or nuclear magnetic resonance spectroscopy.

### Example 7

One or more embodiments of the present disclosure may include an ascorbic acid and gallic acid active agent forming an ascorbic gallate ester as a combined active agent. In some embodiments, a reaction vessel was fitted with a magnetic stirrer and charged with 25 ml concentrated sulphuric acid. 3.5 g (0.2 Molar (M)) of ascorbic acid was added and dissolved. The acid mixture was cooled to 10 C.°. Afterwards, 3.4 g gallic acid powder was added portion-wise with efficient mixing until a homogenous solution was obtained. The reaction was continued at room temperature for eight hours. At the end of the reaction time, the reaction mixture was cooled in ice bath and then neutralized with a 20% sodium hydroxide solution. The product was precipitated by addition of ethanol. A purple color water soluble product was obtained, washed with ethanol, and dried. In these and other embodiments, the product was analyzed by infrared spectroscopy, thermogravimetric analysis, and/or nuclear magnetic resonance spectroscopy.

### Example 8

In some embodiments, food may be treated with an edible preservative in accordance with the present disclosure. For example, the edible preservatives prepared in Examples 1 and 2 were dissolved in water to a 2% solution of the edible preservative. A strawberry was immersed in the solution then dried in air and left in a closed glass container for daily monitoring. Non-treated samples were maintained as control.

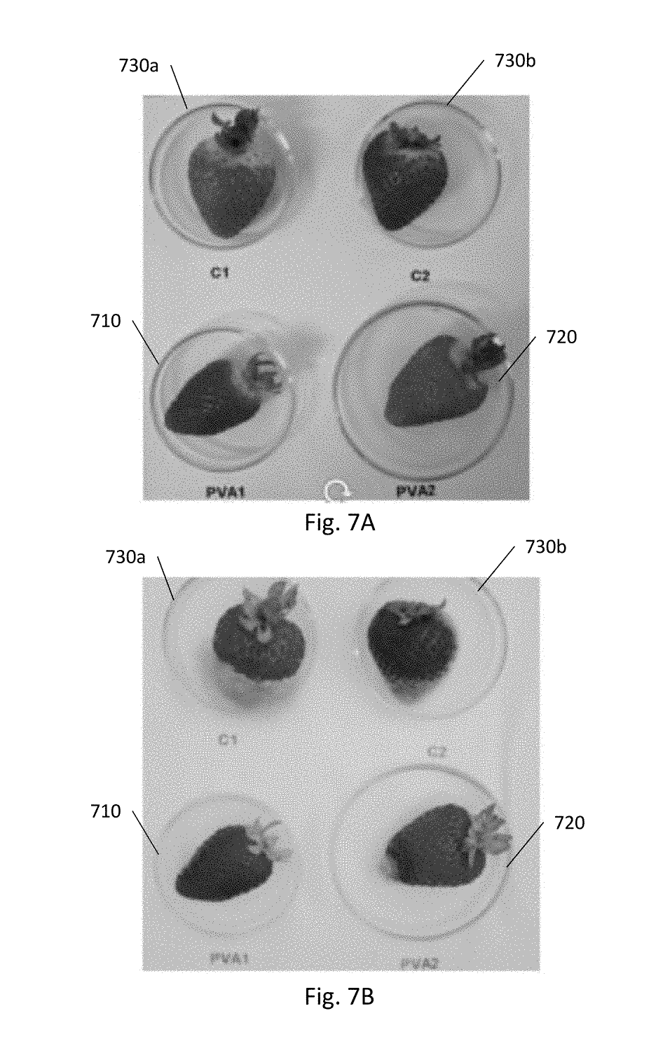

FIGS. 7A and 7B illustrate an example of fruit treated with an edible preservative. For example, FIGS. 7A and 7B illustrate a first strawberry 710 and a second strawberry 720 treated with the edible preservative from Example 1 (PVA ascorbate). Two control strawberries 730a and 730b are also illustrated. FIG. 7A illustrates the first and second strawberries 710 and 720 and the control strawberries 730a and 730b at Day Zero. FIG. 7B illustrates the first and second strawberries 710 and 720 and the control strawberries 730a and 730b at Day Five. The first and second strawberries 710 and 720 were better preserved than the two control strawberries 730a and 730b. The test associated with Example 8 was accelerated by performing the test at ambient temperature.

The present disclosure is not to be limited in terms of the particular embodiments described herein, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The present disclosure is not limited to particular methods, reagents, compounds, compositions, or biological systems, which can, of course, vary. The terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that include A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that include A alone, B alone, C alone, A and B together, A and C together, B and C together, and/or A, B, and C together, etc.). Additionally, virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, the disclosure is also thereby described in terms of any individual member or subgroup of members of the Markush group.

For any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. Also all language such as “up to,” “at least,” and the like may include the number recited and refer to ranges which can be subsequently broken down into sub ranges as discussed above. Finally, a range may include each individual member. Thus, for example, a group having 1-3 cells may refer to groups having 1, 2, or 3 cells. Similarly, a group having 1-5 cells refers to groups having 1, 2, 3, 4, or 5 cells, and so forth.

From the foregoing, various embodiments of the present disclosure have been described herein for purposes of illustration, and various modifications may be made without departing from the scope and spirit of the present disclosure. Accordingly, the various embodiments disclosed herein are not intended to be limiting, with the true scope and spirit being indicated by the following claims.

What is claimed is:

1. An edible preservative, comprising:
a polymer carrier; and
an active agent chemically bonded to the polymer carrier comprising a plurality of functional groups, including at least one of:
a polyphenolic group;
a double bond;
a conjugated double bond; or
a chelating group.

2. The edible preservative of claim 1, wherein the active agent is chemically bonded to the polymer carrier through an ester, amide, or anhydride.

3. The edible preservative of claim 1, wherein the active agent includes a polyphenolic group that is unbound to the polymer carrier and acts as an antioxidant and a free radical scavenger.

4. The edible preservative of claim 1, wherein the active agent includes a double bond that is unbound to the polymer carrier and acts as an oxygen absorber.

5. The edible preservative of claim 1, wherein the active agent includes a chelating group that is unbound to the polymer carrier and acts as a transition metal deactivator.

6. The edible preservative of claim 1, further comprising an aqueous solution in which the polymer carrier is dissolved.

7. The edible preservative of claim 1, wherein the polymer carrier includes a natural polymer.

8. The edible preservative of claim 7, wherein the natural polymer includes at least one of a starch, a cellulose derivative, a chitosan, a gellan, an algenate, a pectin, a whey, or combinations thereof.

9. The edible preservative of claim 1, wherein the polymer carrier includes a modified natural polymer including one of a cellulose ester, hydroxyl methyl cellulose, carboxymethyl cellulose, a starch ester, starch carboxylic acid adducts, esterified pectin, or combinations thereof.

10. The edible preservative of claim 1, wherein the polymer carrier includes a synthetic polymer.

11. The edible preservative of claim 10, wherein the synthetic polymer includes at least one of a polyvinyl alcohol (PVA), a polyethylene glycol (PEG), a polylactone, or combinations thereof.

12. The edible preservative of claim 1, wherein a monomer of the polymer carrier includes at least one functional group to form hydrogen bonds or ionic bonds.

13. The edible preservative of claim 1, wherein the active agent includes one or more of α-carotene, β-carotene, oxalic acid, leucic acid, ascorbic acid, gallic acid, ellagic acid, glutathione, α-tocopherol, α-tocopherol, rosmarinic acid, daidzein, catechins, tocotrienol, p-coumaric acid, vanillic acid, syringic acid, caffeic acid, ferulic acid, cinnamic acid, oleuropein, luteolin, quercetin, myricetin, flavonoids, and combinations thereof.

14. The edible preservative of claim 1, wherein the active agent comprises between approximately 1% and 15% by weight of the edible preservative.

15. The edible preservative of claim 14, wherein the polymer carrier includes a starch and the active agent includes gallic acid, the gallic acid comprising between approximately 2% and 9% by weight of the edible preservative.

16. The edible preservative of claim 14, wherein the polymer carrier includes a starch and the active agent includes leucic acid, the leucic acid comprising between approximately 2% and 5% by weight of the edible preservative.

17. The edible preservative of claim 14, wherein the polymer carrier includes a starch and the active agent includes oxalic acid, the oxalic acid comprising between approximately 3% and 12% by weight of the edible preservative.

18. The edible preservative of claim 14, wherein the polymer carrier includes a starch and the active agent includes ascorbic acid, the ascorbic acid comprising between approximately 4% and 14% by weight of the edible preservative.

19. The edible preservative of claim 14, wherein the polymer carrier includes PVA and the active agent includes gallic acid, the gallic acid comprising between approximately 2% and 11% by weight of the edible preservative.

20. The edible preservative of claim 14, wherein the polymer carrier includes PVA and the active agent includes oxalic acid, the oxalic acid comprising between approximately 2% and 13% by weight of the edible preservative.

21. The edible preservative of claim 14, wherein the polymer carrier includes PVA and the active agent includes leucic acid, the leucic acid comprising between approximately 1% and 3% by weight of the edible preservative.

22. The edible preservative of claim 14, wherein the polymer carrier includes PVA and the active agent includes ascorbic acid, the ascorbic acid comprising between approximately 3% and 14% by weight of the edible preservative.

23. A method of preserving food, the method comprising:
dissolving a polymer carrier and an active agent chemically bonded to the polymer carrier in an aqueous solution, the active agent including at least one of a phenolic group, a double bond, or a conjugated double bond;
treating a food to be preserved with the aqueous solution; and
drying the food to be preserved.

24. The method of claim 23, wherein drying includes exposing the food to an air stream.

25. The method of claim 23, wherein treating the food includes spraying the food with the aqueous solution.

26. The method of claim 23, wherein treating the food, includes dipping the food in the aqueous solution.

27. The method of claim 23, wherein the active agents includes a polyphenolic group, a double bond, and a chelating group.

28. The method of claim 23, wherein the food includes one of a fruit, a vegetable, or a flower.

29. A storage container, comprising:
a body to store a perishable food item; and
a coating along an inner surface of the body, the coating comprising:
a polymer carrier; and
an active agent chemically bonded to the polymer carrier, the active agent comprising:
a polyphenolic group; and
a double bond.

30. The storage container of claim 29, wherein the active agent further includes a chelating group or a conjugated double bond.

31. The storage container of claim 29, wherein the storage container prevents ambient air from entering the body.

32. The storage container of claim 29, wherein the body is made of a polymer material.

33. The storage container of claim 29, wherein the storage container includes a cardboard box, a shipping crate, a polymer foam crate, or a plastic shell.

34. The storage container of claim 29, wherein the body includes a polymer foam slab and a stretchable plastic film around the perishable food and the polymer foam slab.

35. The storage container of claim 29, wherein the perishable food includes a fruit, a vegetable, or meat.

36. The storage container of claim 29, wherein the body includes a removable lid.

37. The storage container of claim 29, wherein the body includes a hinged lid.
